(19) United States
(12) Patent Application Publication
(10) Pub. No.: US 2011/0237314 A1
(43) Pub. Date: Sep. 29, 2011

(54) MOBILE TERMINAL APPARATUS

(75) Inventors: Yoshifumi Kajiwara, Kawasaki (JP); Hiroyuki Takita, Kawasaki (JP); Haruyoshi Yada, Kawasaki (JP); Kenta Sugimori, Kawasaki (JP); Hiroshi Kubo, Kawasaki (JP)

(73) Assignee: FUJITSU LIMITED, Kawasaki-shi (JP)

(21) Appl. No.: 13/050,352

(22) Filed: Mar. 17, 2011

(30) Foreign Application Priority Data
Mar. 26, 2010 (JP) 2010-072092

(51) Int. Cl. H04W 88/02

(52) U.S. Cl. 455/575.4

(57) ABSTRACT

A mobile terminal apparatus includes a first housing having a first surface and a second surface opposite to the first surface, the first surface having a first opening extending therethrough; a first microphone disposed in the first housing adjacent to the first opening; a second housing having a slide surface and an opposite surface opposite to the slide surface, the slide surface being slidable over the second surface of the first housing, the second housing overlapping a portion of the first housing including a position at which the first microphone is disposed when the second housing overlaps the first housing in a minimum area, the opposite surface having a second opening extending therethrough in a part thereof corresponding to the minimum area; and a second microphone disposed in the second housing adjacent to the second opening.

### CROSS-REFERENCE TO RELATED APPLICATIONS

This application is based upon and claims the benefit of priority from the prior Japanese Patent Application No. 2010-72092 filed on Mar. 26, 2010, the entire contents of which are incorporated herein by reference.

### FIELD

The embodiments discussed herein are relates to a mobile terminal apparatus.

### BACKGROUND

Some mobile terminal apparatuses, such as mobile phones, have a fixed housing, on which operation keys and the like are disposed, and a movable housing, on which a liquid crystal display and the like are disposed, and the movable housing is slidably connected to the fixed housing. The size of such a slide-type mobile terminal apparatus is the smallest when the mobile terminal apparatus is in a closed state in which the fixed housing and the movable housing overlap in the maximum overlapping area. When not in use, a user carries a compact mobile terminal apparatus in the closed state. The mobile terminal apparatus provides a user with various functions when the slide-type mobile terminal apparatus is in an open state in which the fixed housing and the movable housing overlap in the minimum overlapping area. For example, a user causes the mobile terminal apparatus to be in the open state by sliding the movable housing relative to the fixed housing, and then uses the mobile terminal apparatus as a telephone.

The functionality of mobile terminal apparatuses has been increased in recent years, and a single terminal usually has multiple functions. For example, a mobile phone has a one-segment broadcasting function or a noise reduction function that reduces ambient noise that interferes with a telephone conversation by using two microphones.

Referring to FIGS. 9 to 13, a slide-type mobile phone including two microphones will be described. FIG. 9 is a perspective view of the front surface side of the slide-type mobile phone. As illustrated in FIG. 9, a mobile phone 200 includes a movable housing 210 and a fixed housing 220. The movable housing 210 and the fixed housing 220 are slidably connected to each other. FIG. 9 illustrates an open state in which the movable housing 210 has been slid relative to the fixed housing 220.

A liquid crystal display and the like are disposed in the movable housing 210. Operation keys and the like are disposed in the fixed housing 220. Hereinafter, a surface of the fixed housing 220 on which the operation keys are disposed as illustrated in FIG. 9 will be referred to as the “front surface”, and a surface of the fixed housing 220 opposite to the surface on which the operation keys are disposed will be referred to as the “back surface”. The fixed housing 220 includes a front case 221, which is positioned on the operation keys side, and a back case 222, which is positioned on the back surface side. An opening 223 is formed in the front case 221. The opening 223 is a through-hole that extends to a microphone disposed on the front surface side in the fixed housing 220.

FIG. 10 is an enlarged view of a region surrounding the microphone that is disposed on the front surface side in the fixed housing 220. As illustrated in FIG. 10, a main circuit board 224 is disposed in the fixed housing 220. A microphone 225 is disposed on the main circuit board 224 at a position close to the opening 223. For example, the microphone 225 is disposed on the main circuit board 224 at a position corresponding to the opening 223. The voice of a user enters the fixed housing 220 through the opening 223 and is picked up by the microphone 225 that is disposed on the front surface side.

FIG. 11 is a perspective view of the back surface side of the slide-type mobile phone 200. As illustrated in FIG. 11, a battery cover case 226, having an opening 227 formed therein, is attached to the back case 222 of the fixed housing 220. The opening 227 is a through-hole that extends to a microphone disposed on the back surface side in the fixed housing 220.

FIG. 12 is an enlarged view of a region surrounding the microphone that is disposed on the back surface side in the fixed housing 220. As illustrated in FIG. 12, a microphone 228 is disposed on the main circuit board 224 in the fixed housing 220 at a position close to the opening 227. The ambient noise around the mobile phone 200 enters the fixed housing 220 through the opening 227, and is picked up by the microphone 228 that is disposed on the back surface side. The mobile phone 200 removes the ambient noise that is picked up by the microphone 228 from the voice that is picked up by the microphone 225, and thereby reduces the ambient noise that interferes with a telephone conversation.

FIG. 13 is a schematic sectional view taken along line I-I of FIG. 9. As illustrated in FIG. 13, the microphone 225 on the front surface side and the microphone 228 on the back surface side are disposed close to each other. For example, the microphone 225 and the microphone 228 are disposed at substantially the same position with respect to the direction perpendicular to the main circuit board 224, so that the microphone 228 picks up the ambient noise around the microphone 225. Therefore, the mobile phone 200 reduces the ambient noise that interferes with a telephone conversation.

Japanese Laid-open Patent Publication No. 2003-338769 describes a mobile wireless terminal device in which a microphone is disposed in a front case. Japanese Laid-open Patent Publication No. 2006-345246 describes a slide-type mobile phone that includes a plurality of microphones.

However, the technologies described in these Publications have a problem in that the sound pickup performance may be impaired. To be specific, when a user uses the mobile phone 200 illustrated in FIG. 9 as a telephone, the opening 223 and the opening 227 may be covered by a user's hand. If the opening 223 and the opening 227 are covered, the microphone 225 may not sufficiently pick up the voice of the user. The microphone 228 may not sufficiently pick up the ambient noise. If the voice and the ambient noise are not sufficiently picked up, a high quality voice may not be transmitted to the party on the other end or the ambient noise may not be sufficiently reduced.

A slide-type mobile terminal apparatus is in the open state when a user uses the terminal as a telephone. Therefore, the position at which a microphone is to be placed in the slide-type mobile terminal apparatus is limited to a certain extent. In particular, for a slide-type mobile terminal apparatus that includes two microphones, the two microphones are disposed close to each other, so that the positions of the microphones are further limited. In a slide-type mobile terminal apparatus including two microphones, the microphones are disposed, for example, at positions illustrated in FIG. 9. As a result, the sound pickup performance may be impaired if the opening is covered.

### SUMMARY

According to an aspect of the embodiment, a mobile terminal apparatus includes a first housing having a first surface and a second surface opposite to the first surface, the first surface having a first opening extending therethrough; a first microphone disposed in the first housing adjacent to the first opening; a second housing having a slide surface and an opposite surface opposite to the slide surface, the slide surface being slidable over the second surface of the first housing, the second housing overlapping a portion of the first housing including the position at which the first microphone is disposed when the second housing overlaps the first housing in a minimum area, the opposite surface having a second opening extending therethrough in a part thereof corresponding to the minimum area; and a second microphone disposed in the second housing adjacent to the second opening.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a perspective view of a mobile phone according to the present embodiment, which is viewed from the front surface side;

FIG. 2 is a perspective view of the mobile phone according to the present embodiment, which is viewed from the back surface side;

FIG. 3 is an enlarged view of a part of the back case, viewed in the direction of arrow A in FIG. 1;

FIG. 4 is an enlarged view of a part of the front case;

FIG. 5 is an enlarged view of the flexible flat cable;

FIG. 6 is an enlarged view of the flexible flat cable;

FIG. 7 is an enlarged view of a region surrounding the microphone disposed on the back surface side in the fixed housing;

FIG. 8 is a schematic sectional view of FIG. 1 taken along line II-II;

FIG. 9 is a perspective view of the front surface side of the slide-type mobile phone;

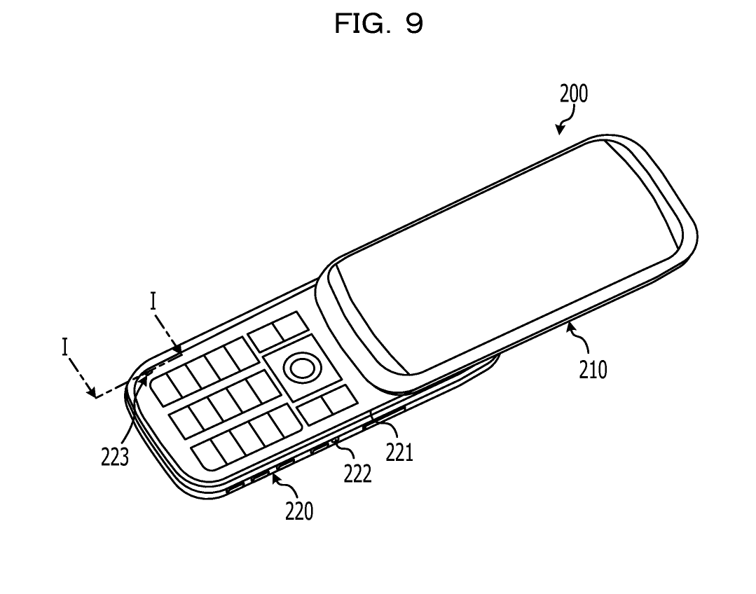

FIG. 10 is an enlarged view of a region surrounding the microphone that is disposed on the front surface side in the fixed housing;

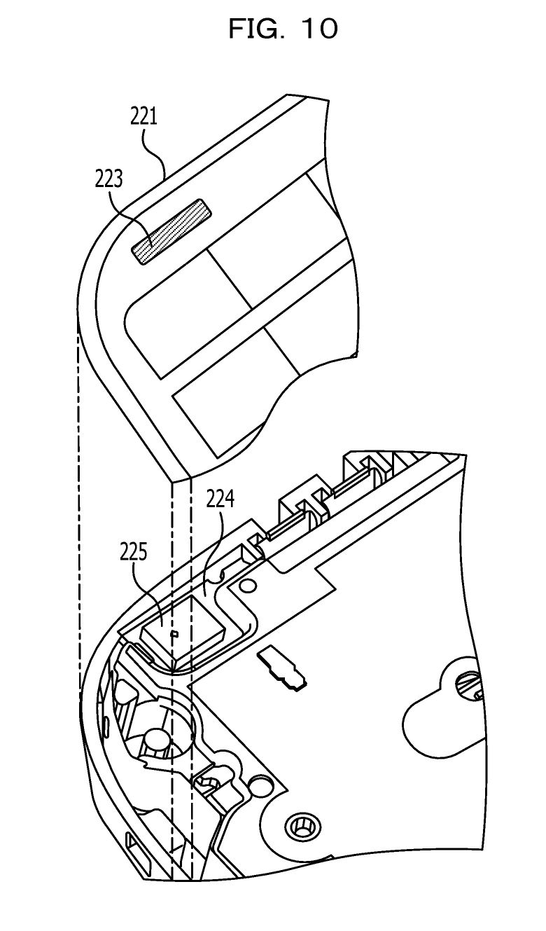

FIG. 11 is a perspective view of the back surface side of the slide-type mobile phone;

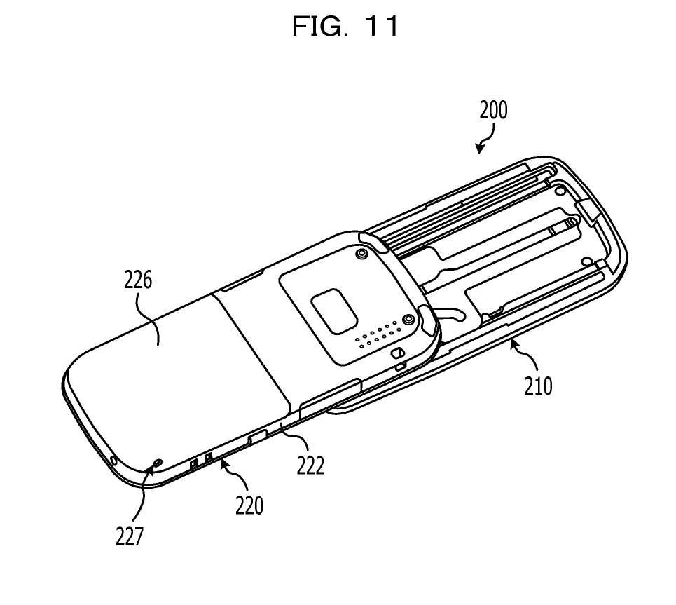

FIG. 12 is an enlarged view of a region surrounding the microphone that is disposed on the back surface side in the fixed housing; and

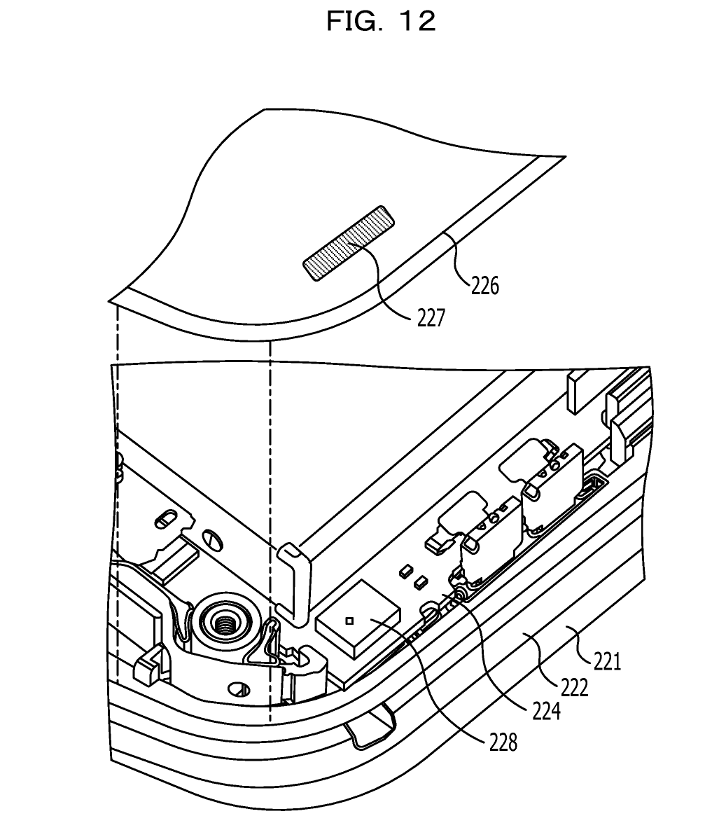

FIG. 13 is a schematic sectional view taken along line I-I of FIG. 9.

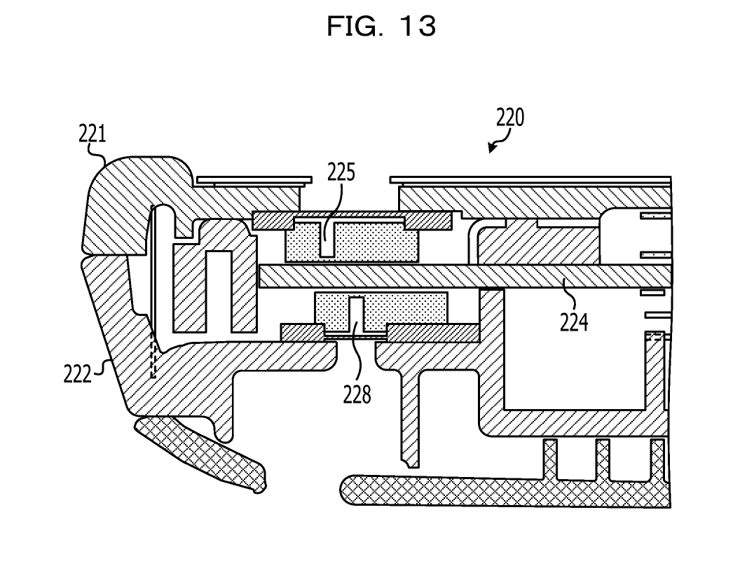

### DESCRIPTION OF EMBODIMENTS

Hereinafter, a mobile terminal apparatus according to a present embodiment will be described with reference to the drawings. The mobile terminal apparatus according to the present embodiment is for example, a mobile phone. However, the mobile terminal apparatus may be a personal digital assistant (PDA) or the like.

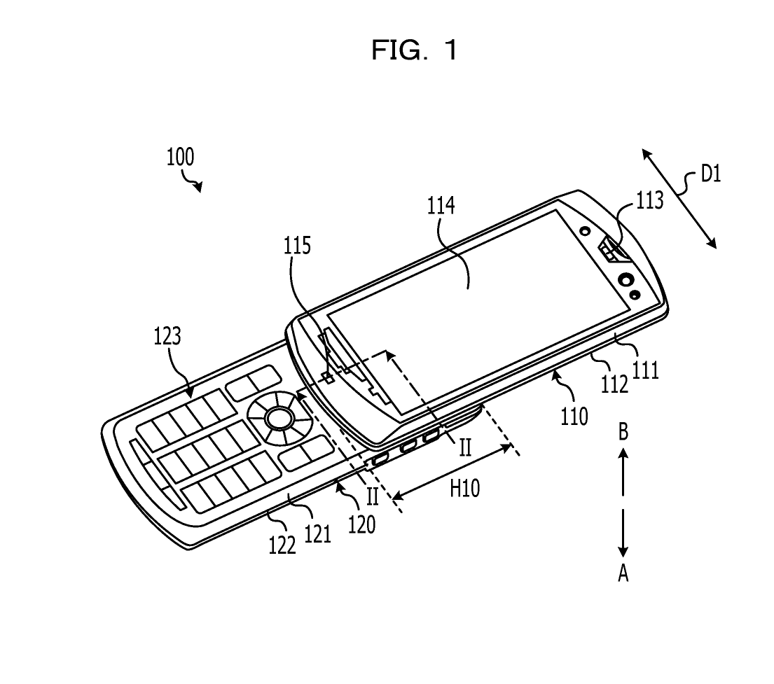

The mobile phone according to the present embodiment includes two microphones. One microphone is disposed in a movable housing, and the other microphone is disposed in a fixed housing. Hereinafter, the disposition of the microphones and the like will be described. Referring to FIG. 1, an external view of the mobile phone according to the present embodiment will be described. FIG. 1 is a perspective view of a mobile phone 100 according to the present embodiment, which is viewed from the front surface side. As illustrated in FIG. 1, the mobile phone 100 according to the present embodiment includes a movable housing 110 and a fixed housing 120.

In the present embodiment, a surface of the movable housing 110 on which a liquid crystal display is disposed may be referred to as the “front surface”. In the present embodiment, a surface of the movable housing 110 that is opposite to the surface on which the liquid crystal display is disposed may be referred to as the “back surface”. In the present embodiment, a surface of the fixed housing 120 on which operation keys are disposed may be referred to as the “front surface”. In the present embodiment, a surface of the fixed housing 120 that is opposite to the surface on which the operation keys are disposed may be referred to as the “back surface”.

The movable housing 110 and the fixed housing 120 are movably connected to each other by a connection portion (not illustrated). The connection portion is a slide mechanism that slidably connects the movable housing 110 and the fixed housing 120 to each other. FIG. 1 illustrates an open state in which the movable housing 110 has been slid and the movable housing 110 and the fixed housing 120 overlap in the minimum overlapping area. When it is not used, the slide-type mobile phone 100 is in a closed state in which the movable housing 110 and the fixed housing 120 substantially completely overlap. When a user operates the operation keys disposed on the fixed housing 120, the user slides the movable housing 110 relative to the fixed housing 120 in the longitudinal direction, and the mobile phone 100 is in an open state.

As illustrated in FIG. 1, the movable housing 110 includes a front case 111 and a back case 112. The front case 111 is on an outer side of the mobile phone 100 in the closed state. The back case 112 is on an inner side of the mobile phone 100 in the closed state.

The front case 111 includes a receiver 113, which receives a telephone voice, and a liquid crystal display 114, which displays various information. An opening 115 extends through the front case 111. The opening 115 is a through-hole that extends to a microphone (not illustrated) that is disposed on the front surface side in the movable housing 110. In the example illustrated in FIG. 1, the opening 115 is formed in the front case 111 of the movable housing 110 at a position below the liquid crystal display 114. In other words, the opening 115 is located at a position close to the center of the mobile phone 100 in the longitudinal direction when the mobile phone 100 is in the open state. In the example illustrated in FIG. 1, the opening 115 is located at a position close to the center of the width D1 of the movable housing 110 in lateral direction.

In the mobile phone 100 according to the present embodiment, the opening 115 is formed at a position below the liquid crystal display 114. Therefore, when a user uses the mobile phone 100 as a telephone, a user is unlikely to cover the opening 115. This is because, when a user uses the mobile phone 100 as a telephone, the user does not usually hold a part of the mobile phone 100 that is close to the center of the mobile phone 100 in the longitudinal direction. In the mobile phone 100 according to the present embodiment, the opening 115 is located close to the center of the width D1 of the movable housing 110 in the lateral direction. When a user uses the mobile phone 100 as a telephone, the user does not hold a part of the mobile phone 100 that is close to the center in the longitudinal direction and close to the center in the lateral direction. Therefore, with the mobile phone 100 according to the present embodiment, the opening 115 is prevented from being covered by a user.

When the fixed housing 120 and the movable housing 110 overlap in the minimum area H10, the fixed housing 120 overlaps a part of the movable housing 110 in which the opening 115 is formed. In other words, regardless of whether the mobile phone 100 is in the open state or in the closed state, the fixed housing 120 overlaps the opening 115 formed in the movable housing 110.

As illustrated in FIG. 1, the fixed housing 120 includes a front case 121 and a back case 122. The front case 121 is on an inner side when the mobile phone 100 is in the closed state. The back case 122 is on an outer side when the mobile phone 100 is in the closed state. A keypad 123 is disposed on the front case 121. The keypad 123 includes operation keys, such as a multifunction key, an enter key, a dial key, and numeric keys.

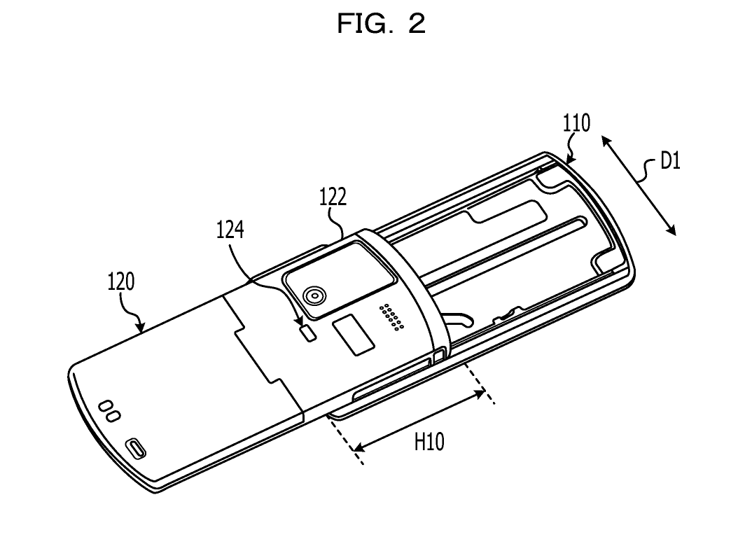

Referring to FIG. 2, an external view of the back surface side of the mobile phone 100 according to the present embodiment will be described. FIG. 2 is a perspective view of the mobile phone 100 according to the present embodiment, which is viewed from the back surface side. As illustrated in FIG. 2, an opening 124 extends through the back case 122 of the fixed housing 120.

The opening 124 is a through-hole that extends to a microphone (not illustrated) that is disposed on the back surface side in the fixed housing 120. The opening 124 is formed in the back case 122 at a position in the minimum area H10, which is the smallest area in which the movable housing 110 and the fixed housing 120 overlap. In the example illustrated in FIG. 2, the opening 124 is located close to the center of the width D1 of the fixed housing 120 in the lateral direction.

In the mobile phone 100 according to the present embodiment, the opening 124 is located close to the center of the fixed housing 120. A user is unlikely to cover the opening 124 when the mobile phone 100 is used as a telephone.

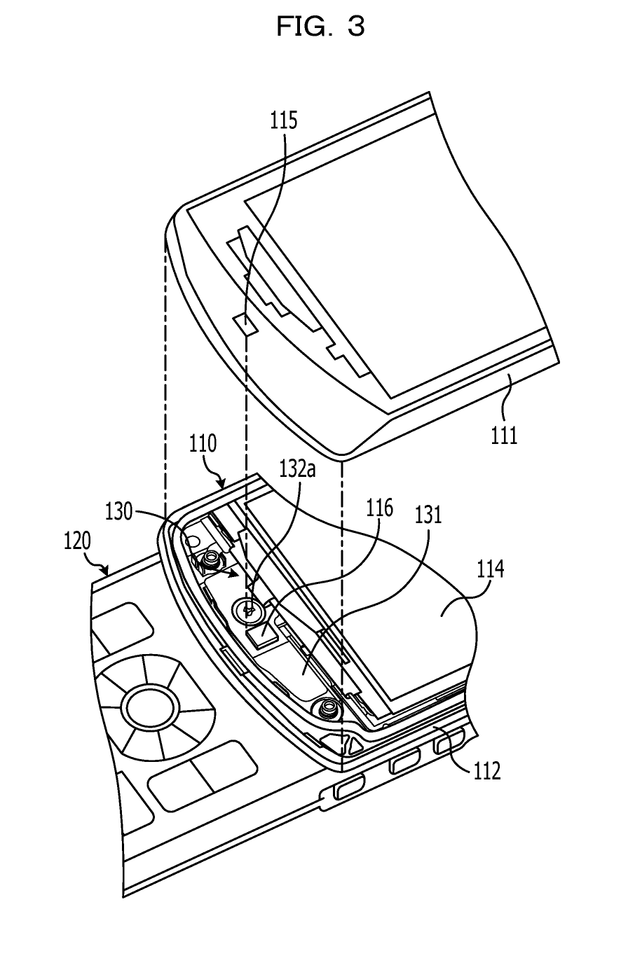

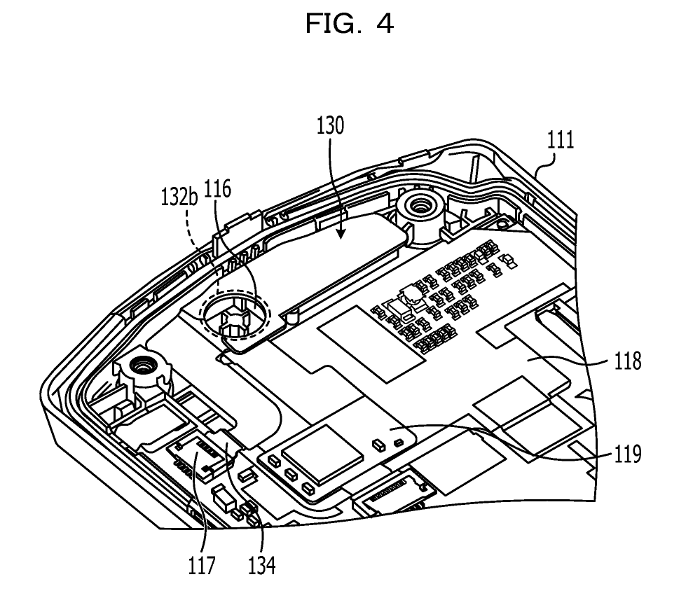

Referring to FIGS. 3 and 4, a microphone that is disposed in the movable housing 110 will be described. FIGS. 3 and 4 are enlarged views of a region surrounding the microphone that is disposed on the front surface side in the movable housing 110. FIG. 3 is an enlarged view of a part of the back case 112, viewed in the direction of arrow A in FIG. 1. FIG. 4 is an enlarged view of a part of the front case 111, viewed in the direction of arrow B in FIG. 1.

As illustrated in FIG. 3, the liquid crystal display 114, a flexible flat cable 130, and other components are disposed in the back case 112 of the movable housing 110. The liquid crystal display 114 is, for example, a liquid crystal display (LCD) module, and the liquid crystal display 114 displays various information. The liquid crystal display 114 may be used as a touch panel in cooperation with a touch pad (not illustrated) and function as an input device.

The flexible flat cable 130 is integrated with a frequency modulation (FM) transmitter antenna 131. The flexible flat cable 130 is connected to the electrical system (not illustrated) in the movable housing 110. That is, the flexible flat cable 130 electrically connects the FM transmitter antenna 131 to the electrical system (not illustrated) in the movable housing 110. The flexible flat cable 130 is fastened to the back case 112 with a fastener 132a.

In the movable housing 110 of the present embodiment, a microphone 116 is disposed close to the opening 115 in the front case 111. To be specific, as illustrated in FIG. 3, the microphone 116 is disposed on the flexible flat cable 130. For example, the microphone 116 is disposed on the flexible flat cable 130 at a position corresponding to the opening 115. The flexible flat cable 130 electrically connects the microphone 116 to the electrical system (not illustrated) in the movable housing 110. The voice of a user enters the movable housing 110 through the opening 115 and is picked up by the microphone 116, which is disposed on the front surface side in the movable housing 110.

Referring to FIG. 4, how the flexible flat cable 130 illustrated in FIG. 3 is disposed in the front case 111 will be described. As illustrated in FIG. 4, a flexible printed circuit (FPC) connector 117, an LCD flexible flat cable 118, a touch panel flexible flat cable 119, and other components are disposed in the front case 111.

The FPC connector 117 is a connector to which the flexible flat cable 130 is connected. The FPC connector 117 electrically connects the FM transmitter antenna 131 and the microphone 116, which are disposed in/on the flexible flat cable 130, to a circuit board and the like. The LCD flexible flat cable 118 electrically connects the LCD module of the liquid crystal display 114 to the circuit board and the like. The touch panel flexible flat cable 119 electrically connects the touch pad (not illustrated) to the circuit board and the like.

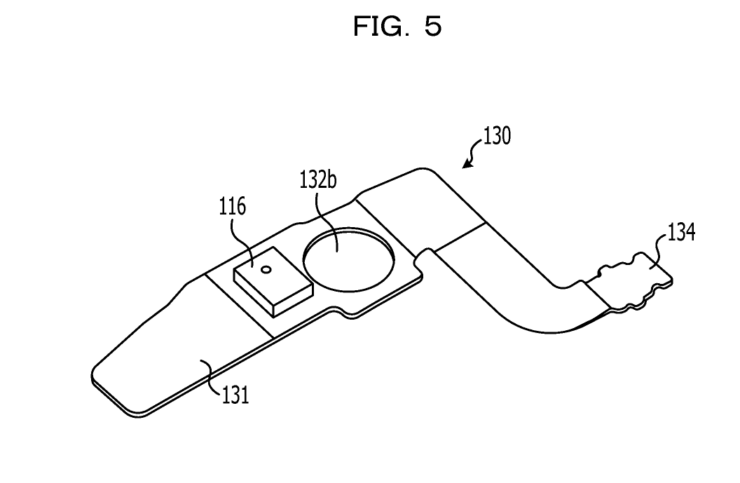

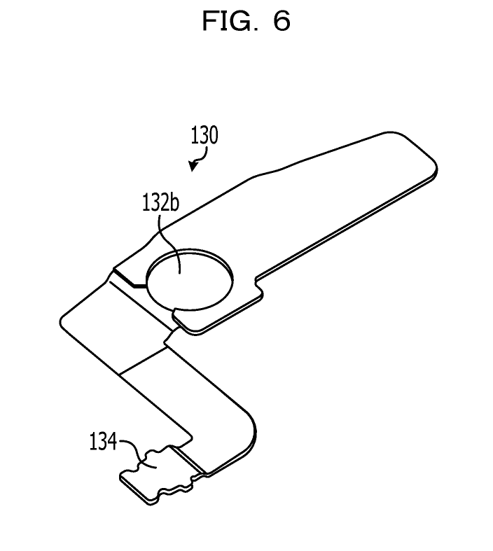

Referring to FIGS. 5 and 6, the flexible flat cable 130 will be described. FIGS. 5 and 6 are enlarged views of the flexible flat cable 130. As illustrated in FIGS. 5 and 6, a cable hole 132b is formed in the flexible flat cable 130. The fastener 132a, which is illustrated in FIG. 3, is inserted through the cable hole 132b. The fastener 132a, which is illustrated in FIG. 3, is inserted through the cable hole 132b, and fastens the flexible flat cable 130 to the back case 112.

As illustrated in FIGS. 5 and 6, the flexible flat cable 130 includes the FM transmitter antenna 131 at one end thereof and an FPC connector plug 134 at the other end thereof. The FPC connector plug 134 is plugged into the FPC connector 117 illustrated in FIG. 4. When the FPC connector plug 134 is plugged into the FPC connector 117, the flexible flat cable 130 is connected to the electrical system (not illustrated) in the movable housing 110. The flexible flat cable 130 electrically connects the FM transmitter antenna 131 and the microphone 116 to the electrical system (not illustrated) in the movable housing 110.

In the mobile phone 100 according to the present embodiment, the microphone 116 is disposed on the flexible flat cable 130 to which the FM transmitter antenna 131 is connected. Therefore, an independent flexible flat cable for the microphone 116 is not used. As a result, with the mobile phone 100 according to the present embodiment, an increase in the number of components is prevented.

In the mobile phone 100 according to the present embodiment, the microphone 116 is disposed in a vacant space on the flexible flat cable 130. Therefore, additional space for housing the microphone 116 is not provided. As a result, with the mobile phone 100 according to the present embodiment, an increase in the space for mounting components, including the microphone 116, is prevented.

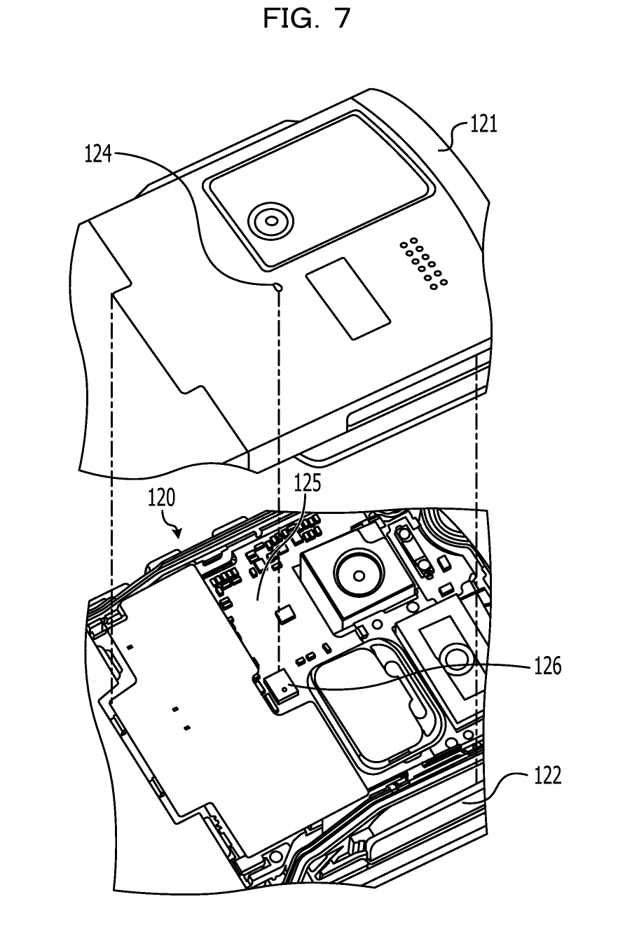

Referring to FIG. 7, a microphone disposed in the fixed housing 120 will be described. FIG. 7 is an enlarged view of a region surrounding the microphone disposed on the back surface side in the fixed housing 120. As illustrated in FIG. 7, a rear circuit board 125 is disposed in the fixed housing 120. Various electronic components are mounted on the rear circuit board 125.

In the fixed housing 120 of the present embodiment, a microphone 126 is disposed on the rear circuit board 125 at a position close to the opening 124 that is formed in the back case 122. For example, the microphone 126 is located at a position on the rear circuit board 125 corresponding to the opening 124. In this case, the ambient noise around the mobile phone 100 enters the fixed housing 120 through the opening 124 and is picked up by the microphone 126.

The mobile phone 100 according to the present embodiment removes the ambient noise that is picked up by the microphone 126 from the voice that is picked up by the microphone 116, and thereby reduces the ambient noise that interferes with a telephone conversation.

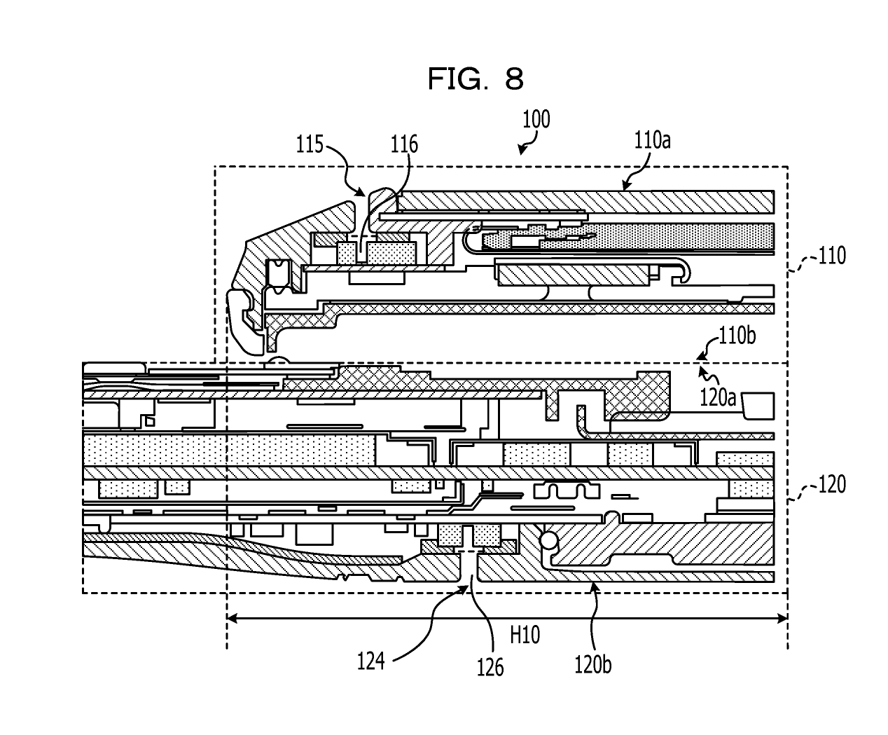

Referring to FIG. 8, the relationship between the position of the microphone 116 and the position of the microphone 126 in the mobile phone 100 according to the present embodiment will be described. FIG. 8 is a schematic sectional view of FIG. 1 taken along line II-II. FIG. 8 illustrates the open state in which the movable housing 110 has been slid and the movable housing 110 and the fixed housing 120 overlap in the minimum overlapping area.

As illustrated in FIG. 8, the movable housing 110 has a display surface 110a, which is positioned on the liquid crystal display 114 side, and a back surface 110b, which is opposite to the display surface 110a. In the movable housing 110, the opening 115 extends through the display surface 110a. The microphone 116 is disposed close to the opening 115 in the movable housing 110.

As illustrated in FIG. 8, the fixed housing 120 has a slide surface 120a, which slides over the back surface 110b of the movable housing 110, and a back surface 120b, which is opposite to the slide surface 120a. The slide surface 120a is on the keypad 123 side.

When the movable housing 110 is slid over the fixed housing 120 and the fixed housing 120 and the movable housing 110 overlap in the minimum area H10, the fixed housing 120 overlaps a part of the movable housing 110 in which the microphone 116 is disposed. In the fixed housing 120, the opening 124 extends through a part of the back surface 120b corresponding to the minimum area H10. The microphone 126 is disposed close to the opening 124 in the fixed housing 120.

In the mobile phone 100 according to the present embodiment, when the fixed housing 120 and the movable housing 110 overlap in the minimum area H10, the openings 115 and 124 are positioned in the minimum area H10. In other words, in the mobile phone 100 according to the present embodiment, the microphones 116 and 126 are positioned in the minimum area H10.

In a mobile phone that includes two microphones, such as the mobile phone 100, it is preferable that the two microphones be positioned close to each other. This is because the ambient noise that interferes with a telephone conversation is reduced by removing the ambient noise picked up by one of the microphones from the voice picked up by the other microphone. By positioning the two microphones close to each other, the other microphone picks up the ambient noise around the microphone that picks up the voice. As a result, the mobile phone reduces the ambient noise that interferes with a telephone conversation. When a user uses a slide-type mobile phone, such as the mobile phone 100, as a telephone, the mobile phone is used in the open state. As illustrated in FIG. 8, when the mobile phone 100 according to the present embodiment is in the open state, the microphone 116 and the microphone 126 are positioned close to each other. Therefore, the mobile phone 100 according to the present embodiment reduces the ambient noise that interferes with a telephone conversation.

In the mobile phone 100 according to the present embodiment, the opening 115 is located below the liquid crystal display 114 on the movable housing 110. The microphone 116 for picking up the voice of a user is disposed close to the opening 115 in the movable housing 110. In the mobile phone 100 according to the present embodiment, the opening 124 is located close to the center of the fixed housing 120. The microphone 126 for picking up the ambient noise is disposed close to the opening 124 in the fixed housing 120. As illustrated in FIG. 8, when the mobile phone 100 according to the present embodiment is in the open state, the microphone 116 and the microphone 126 are positioned close to each other.

When the mobile phone 100 according to the present embodiment is used as a telephone, a user is unlikely to cover the openings 115 and 124. Therefore, the mobile phone 100 according to the present embodiment picks up the voice of the user and the ambient noise with high precision. With the mobile phone 100 according to the present embodiment, impairment of the sound pickup performance is prevented, so that the ambient noise that interferes with a telephone conversation is reduced and the voice of a user is transmitted to the party on the other end with high quality.

In the mobile phone 100 according to the present embodiment, the opening 115 is formed in the front case 111 of the movable housing 110 at a position close to the center of the width D1 of the movable housing 110 in the lateral direction. That is, the microphone 116 is disposed in the movable housing 110 at a position close to the center of the width D1 of the movable housing 110 in the lateral direction. The opening 124 is formed in the back case 122 of the fixed housing 120 at a position close to the center of the width D1 of the fixed housing 120 in the lateral direction. The microphone 126 is disposed in the fixed housing 120 at a position close to the center of the width D1 of the fixed housing 120 in the lateral direction. When the mobile phone 100 according to the present embodiment is used as a telephone, the opening 115 and the opening 124 are prevented from being covered by a user. As a result, with the mobile phone 100 according to the present embodiment, the ambient noise that interferes with a telephone conversation is reduced, and the voice of a user is transmitted to the party on the other end with high quality. The mobile phone 100 according to the present embodiment has an integrated design because the opening 115 and the opening 124 are formed at positions close to the center of the width D1 of the housing in the lateral direction.

In the mobile phone 100 according to the present embodiment, the microphone 116 is disposed in a vacant space on the flexible flat cable 130 that is connected to the FM transmitter antenna 131. Thus, with the mobile phone 100 according to the present embodiment, increase in the number of components such as a flexible flat cable is prevented and an increase in the space for mounting components is prevented.

In the mobile phone 100 according to the present embodiment, the opening 115 is formed in the movable housing 110 on the liquid crystal display 114 side. Therefore, even in the closed state, the opening 115 is not covered by the housing, whereby the voice of a user is picked up with high precision.

In the embodiment described above, as in the example illustrated in FIG. 1, the opening 115 is formed in the movable housing 110 at a position close to the center of the width D1 of the movable housing 110 in the lateral direction, and the opening 124 is formed in the fixed housing 120 at a position close to the center of the width D1 in the lateral direction. The opening 115 need not be formed in the movable housing 110 at a position close to the center of the width D1 of the movable housing 110 in the lateral direction. The opening 124 need not be formed in the fixed housing 120 at a position close to the center of the width D1 of the fixed housing 120 in the lateral direction. The microphone 116 is disposed close to the opening 115, and the microphone 126 is disposed close to the opening 124. It is preferable that the openings 115 and 124 be disposed at substantially the same position in a direction perpendicular to the movable housing 110 and the slide surface of the fixed housing 120. In this case, the microphone 116 and the microphone 126 are positioned close to each other even if the openings 115 and 124 are not formed in the movable housing 110 and the fixed housing 120 at positions close to the center of the width D1 of the movable housing 110 and the fixed housing 120 in the lateral direction.

In the embodiment described above, the microphone 116 is disposed on the flexible flat cable 130 that is integrated with the FM transmitter antenna 131. The flexible flat cable on which the microphone 116 is disposed need not be integrated with the FM transmitter antenna, and may be integrated with another type of microphone.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that various changes, substitutions, and alterations could be made hereto without departing from the spirit and scope of the invention.

What is claimed is:

1. A mobile terminal apparatus comprising:
a first housing having a first surface and a second surface opposite to the first surface, the first surface having a first opening extending therethrough;
a first microphone disposed in the first housing adjacent to the first opening;
a second housing having a slide surface and an opposite surface opposite to the slide surface, the slide surface being slidable over the second surface of the first housing, the second housing overlapping a portion of the first housing including a position at which the first microphone is disposed when the second housing overlaps the first housing in a minimum area, the opposite surface having a second opening extending therethrough in a part thereof corresponding to the minimum area; and
a second microphone disposed in the second housing adjacent to the second opening.

2. The mobile terminal apparatus according to claim 1,
wherein the first microphone is disposed at about the center of a width of the first housing in a lateral direction, and the second microphone is disposed at about the center of a width of the second housing in the lateral direction.

3. The mobile terminal apparatus according to claim 1,
wherein the first microphone is connected to a cable that electrically connects an antenna to an electrical system, the antenna and the electrical system being disposed in the first housing.
